(19) United States
(12) Patent Application Publication
(10) Pub. No.: US 2011/0035697 A1
(43) Pub. Date: Feb. 10, 2011

(54) AUTONOMOUS DISPLAY MANAGEMENT OF GRAPHICAL INTERFACES

(75) Inventors: Brendan D. Rempel, Redmond, WA (US); Xianming Wu, Redmond, WA (US); Milong Sabandith, Seattle, WA (US); Adam Avraham Ferman, Redmond, WA (US); Sylvester M. La Blanc, Issaquah, WA (US); Oren Winter, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/537,517

(22) Filed: Aug. 7, 2009

(51) Int. Cl. G06F 3/048

(52) U.S. Cl. 715/781; 715/809

(57) ABSTRACT

A method of autonomously managing selective display of graphical interfaces displayable by a computing device is provided. The method includes detecting creation of an application window or dialog box attempting to be displayed by the computing device. The method includes obtaining display characteristics for a created application window or dialog box. The display characteristics include display configuration parameters and displayable contents of the created application window or dialog box. The method includes identifying the display characteristics from different display characteristics linked to corresponding display management actions. The method includes performing a display management action that corresponds to the display characteristics to selectively display the application window or dialog box or performing a display management action that is not directly associated with display of the application window or dialog box.

### BACKGROUND

Computing devices used in public display applications such as kiosks, or digital signs, may execute an operating system that runs under a public display application program that displays windows or dialog boxes to a user or the public that are specific to that application. For example, an airline reservation kiosk may display dialog boxes prompting a user to perform actions related to airline reservations, such as checking in for a flight or booking luggage. Occasionally, the operating system may encounter unexpected events that cause a window or dialog box that includes a message unrelated to the public display application program to be displayed to the user or the public. This interferes with the ability of the user to interact with the public display application program and may cause the user or the public to become confused, sometimes resulting in the user or the public avoiding use of the computing device. Further, in many cases, during use of the public display application program user interaction may be constrained such that the user does not have the ability to respond to the unrelated message. As such, the unrelated message may stay visible until an administrator is available to handle it, which produces an unprofessional appearance of the kiosk.

### SUMMARY

A method of autonomously managing selective display of graphical interfaces displayable by a computing device is provided. The method includes detecting creation of an application window or dialog box to be displayed by the computing device. The method includes obtaining display characteristics for a created application window or dialog box. The display characteristics include display configuration parameters and displayable contents of the created application window or dialog box. The method includes identifying the display characteristics from different display characteristics linked to corresponding display management actions. The method includes performing a display management action that corresponds to the display characteristics to selectively display the application window or dialog box.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of a computing device on which graphical interfaces may be selectively displayed and/or dispensed with according to the present disclosure.

FIG. 2 is a schematic view of an embodiment of a screening task program configured to manage selective display of and/or dispensing with graphical interfaces on the computing device of FIG. 1.

FIG. 3 is a flow diagram of an embodiment of a method of autonomously managing selective display of and/or dispensing with graphical interfaces displayable by a computing device.

FIG. 4 is a schematic diagram of a use case that illustrates behavior of the screening task program of FIG. 2.

FIG. 5 is a schematic diagram of another use case that illustrates behavior of the screening task program of FIG. 2.

FIG. 6 is a schematic diagram of another use case that illustrates behavior of the screening task program of FIG. 2.

FIG. 7 is a schematic diagram of another use case that illustrates behavior of the screening task program of FIG. 2.

### DETAILED DESCRIPTION

The present disclosure relates to managing graphical interfaces displayable by a computing device. More particularly, the present disclosure relates to autonomously managing selective display of graphical interfaces by a computing device running a public display application program such that graphical interfaces unrelated to the public display application program are not displayed to the user and are dispensed with. The approaches described herein may allow for users to interact with the public display application program without interference from display of unrelated graphical interfaces. Moreover, graphical interfaces may be dispensed with so as to not disrupt operation of the computing device.

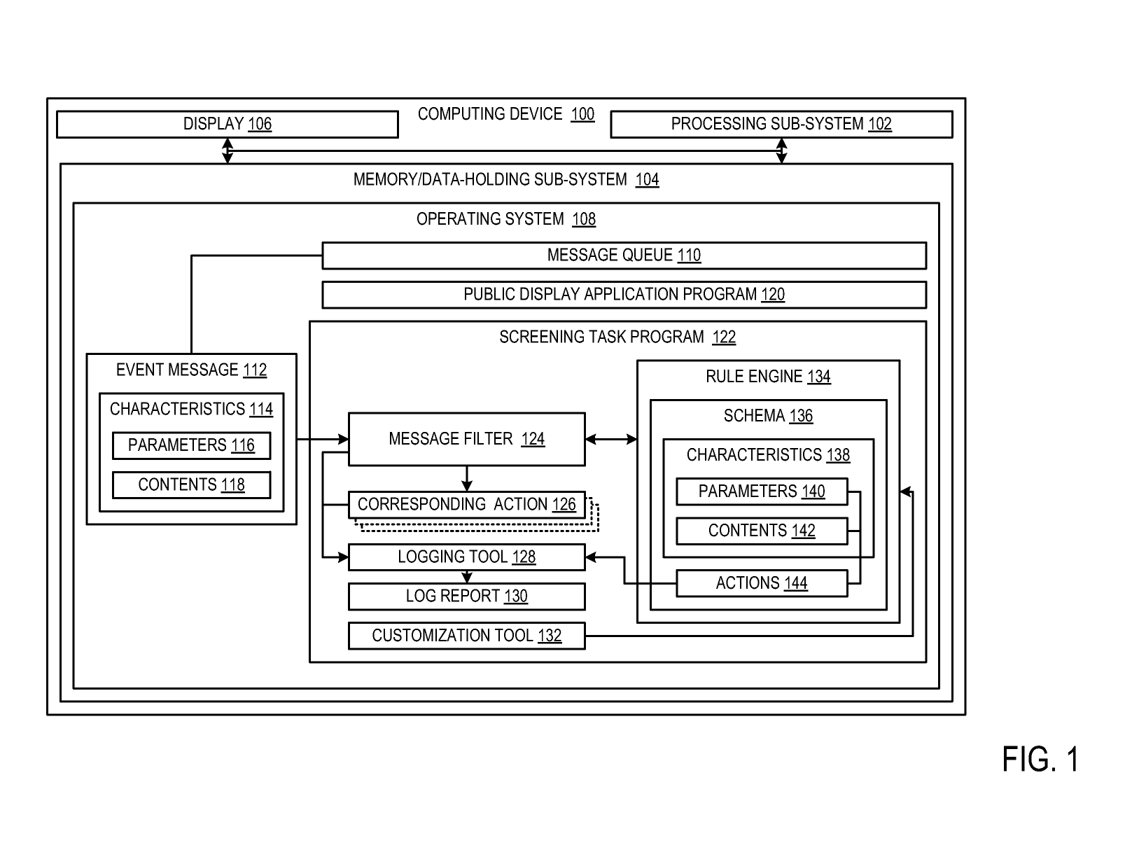

FIG. 1 is a schematic view of an embodiment of a computing device 100 according to the present disclosure. Discussion of computing device 100, at times, may focus on a public display implementation, in which the configuration employed for the computing device may facilitate simple, straightforward user interaction with the computing device. For example, the computing device may be implemented as a kiosk that accepts user input via a touch screen display. As another example, the computing device may be implemented as an automated teller machine (ATM) that accepts user input via a keypad.

Furthermore, in such public display configurations, user interaction and/or user access to the computing device may be constrained to specific input in order to simplify the user experience and to inhibit the configuration of the computing device from being changed in an unplanned manner. The computing device may display graphical interfaces, such as application windows or dialog boxes that prompt a user to perform the specific input. For example, the kiosk may include a dialog box that includes control buttons that may be tapped by a user to display information about a topic. As another example, the ATM may display an application window prompting a user to enter a personal identification number into the keypad. In addition to or instead of public display implementations, the described computing device may be employed in other settings in which users are directed to provide specific user input and are blocked from aspects of selected application programs or the operating system.

While public display applications may be used herein as an example for purposes of explanation, the present disclosure is not limited to public display systems. As an example of another application, a user may have a home computing system that functions as a digital video recorder (DVR). This system may run specialized DVR software that the user interfaces with via a remote control. In such a system, display of messages unrelated to the DVR software may be undesirable and or may be managed in an automated fashion.

As another example, an embedded system may be located in an area that is not easy to reach by system administrators. In this case, the system may be configured by system administrators to automatically manage some application windows or other messages to let the system continue running

This is also relevant for devices which are intended to be operating system agnostic. In other words, it is intended for the customer to not be able to recognize what operating system is running because the device is intended to be viewed as an embedded device owned by an original equipment manufacturer (OEM).

This is also relevant for headless devices or devices that do not have a user interface (UI) where unhandled windows can cause the system to have unintended behavior (e.g., OS hangs waiting for input). This can also be used on a headless device, such as an industrial automation robot controller, to deal with windows.

Continuing with FIG. 1, computing device 100 comprises a processing sub-system 102, a memory/data-holding sub-system 104, and a display 106. The processing sub-system 102 may include one or more physical devices configured to execute one or more instructions. For example, the processing sub-system may be configured to execute one or more instructions that are part of one or more application programs, routines, objects, components, data structures, or other logical constructs. Such instructions may be implemented to perform a task, implement a data type, transform the state of one or more devices, or otherwise arrive at a desired result. The processing sub-system may include one or more processors that are configured to execute software instructions. Additionally or alternatively, the processing sub-system may include one or more hardware or firmware logic machines configured to execute hardware or firmware instructions. The processing sub-system may optionally include individual components that are distributed throughout two or more devices, which may be remotely located in some embodiments.

The memory/data-holding sub-system 104 may include one or more physical devices configured to hold data and/or instructions executable by the processing sub-system to implement the herein described methods and processes. When such methods and processes are implemented, the state of memory/data-holding sub-system 104 may be transformed (e.g., to hold different data). The memory/data-holding sub-system 104 may include removable media and/or built-in devices. The memory/data-holding sub-system 104 may include optical memory devices, semiconductor memory devices, and/or magnetic memory devices, among others. The memory/data-holding sub-system 104 may include devices with one or more of the following characteristics: volatile, nonvolatile, dynamic, static, read/write, read-only, random access, sequential access, location addressable, file addressable, and content addressable. In some embodiments, processing sub-system 102 and memory/data-holding sub-system 104 may be integrated into one or more common devices, such as an application specific integrated circuit or a system on a chip. In some embodiments, memory/data-holding sub-system 104 may include a form of computer-readable removable media, which may be used to store and/or transfer data and/or instructions executable to implement the herein described methods and processes.

The display 106 may be used to present a visual representation of data held by memory/data-holding sub-system 104. As the herein described methods and processes change the data held by the data-holding subsystem, and thus transform the state of the data-holding subsystem, the state of display 106 may likewise be transformed to visually represent changes in the underlying data. The display 106 may include one or more display devices utilizing virtually any type of technology. Such display devices may be combined with processing sub-system 102 and/or memory/data-holding sub-system 104 in a shared enclosure, or such display devices may be peripheral display devices.

The memory/data-holding sub-system 104 may hold instructions that take the form of an operating system 108. The operating system 108 may act as an interface between computing applications hosted by the operating system and processing sub-system 102 as well as other hardware components of computing device 100. The operating system 108 may be configured to coordinate events to manage processing resources of processing sub-system 102. The operating system 108 may include a message queue 110 of operating system event messages that signal occurrence of virtually any suitable event that takes place within operating system 108. The event messages in message queue 110 may be used by operating system 108 to manage processing resources of processing sub-system 102 in order to execute application programs within the operating system. The event messages in message queue 110 may be caused by user input, an application program, operating system 108, or another suitable source.

As discussed above, computing device 100 may be configured for use in a pubic display setting. A public display application program 120 may be hosted by operating system 108. The public display application program 120 may be configured to provide graphical interface(s) such as application window(s) and/or dialog box(s) that prompt targeted user interaction. In some embodiments, public display application program 120 may be executed in a public display session of operating system 108 in which application windows or dialog boxes related to public display application program 120 are displayed and unrelated application windows or dialog boxes are not displayed and are dispensed with. This may facilitate user input that is constrained or directed to produce targeted user interaction with public display application program 120 in order to provide a straightforward user experience and to inhibit unwanted computing device configuration changes. In other words, a user may have constrained access to operating system 108 and/or may be blocked from interacting with application programs other than public display application program 120.

In such embodiments, sessions of operating system 108 may be initiated other than the public display session. Some sessions of the operating system may permit application windows or dialog boxes unrelated to the public display application program to be displayed to the user. Further, some sessions may permit less constrained or full user access to application programs other than the public display application program and/or the operating system. For example, an on-demand administrative session may be initiated to allow an administrator to make changes to the operating system and/or application programs.

A screening task program 122 may be hosted by operating system 108. The screening task program 122 may run beneath public display application program 120 or may be run in the background such that it is invisible to the user. The screening task program 122 may be configured to prevent all graphical interfaces unrelated to public display application program 120 from being displayed by display 106. In embodiments where no display exists (e.g., headless applications), the screening task program may be configured to manage graphical interfaces so as not to present them on a “virtual” display or otherwise interfere with computing operations.

In particular, screening task program 122 may comprise a message filter 124 configured to receive event messages from message queue 110. In some embodiments, screening task program 122 may invoke an application programming interface (API) that hooks all event messages in message queue 110. In some embodiments, screening task program 122 may behave similar to a service except that the screening task program may run outside of a particular session of the operating system so that it may receive all event messages of the operating system.

The message filter 124 may be configured to filter or ignore event messages that do not include a graphical interface in the form of an application window or dialog box. As used herein, the terms “application window” and “dialog box” are used to collectively refer to any type of GUI element that may be displayed on display 106.

Event messages that do include an application window or dialog box may be passed through message filter 124. The message filter 124 may be configured to obtain display characteristics 114 of an event message 112 that does include an application window or dialog box. The display characteristics 114 may comprise display configuration parameters 116 and contents 118 of the application window or dialog box. The display configuration parameters 116 may include one or more of a window's application process name, an application class identifier, and title text of event message 112. The contents 118 of the application window or dialog box may include values associated with graphical controls, including but not limited to labels, buttons, custom controls, etc. within the application window or dialog box.

The message filter 124 may be operatively coupled with a rule engine 134. The rule engine 134 may comprise a schema 136 that links different display characteristics 138 to corresponding display management actions 144. More particularly, the different display characteristics 138 may comprise different display configuration parameters 140 and different contents 142. Each display characteristic of the different display characteristics 138 may be linked to one or more corresponding display management actions of different display management actions 144.

In some embodiments, rule engine 134 may be implemented in extensive mark-up language (XML). The XML may be cached to enhance performance in identifying display characteristics of an event message that comprises an application window or dialog box. In some embodiments, rule engine 134 may be hard-coded into the screening task program and configurable via customization of the program. In such embodiments, the different display characteristics may be linked to corresponding display management action(s) in the hard-code. In some embodiments, the rule engine could also be hosted on a remote server (e.g., on the Intranet) and the screen task program may access the remote server to communicate with the rule engine. Moreover, the rule engine on the remote server may be updated as new scenarios are discovered. In some embodiments, the screening task program may use wild card identifiers to search the schema (or hard) code for display characteristics linked to display management actions. As such, partial search terms may be used for searching that may produce a quicker and more efficient search for display management actions.

The message filter 124 may be configured to identify display characteristics in schema 136 linking different display characteristics 138 to corresponding display management actions 144 for an event message that includes an application window or dialog box. In other words, message filter 124 may send display characteristics 114 of event message 112 to rule engine 134 in order to retrieve corresponding display management action(s) 126 to be performed on the application window or dialog box of event message 112. The screening task program may be configured to perform corresponding display management action(s) 126 on the application window or dialog box of the event message to display the application window or dialog box if it is related to public display application program 120. Otherwise, the corresponding display management action(s) 126 may dispense with the application window or dialog box such that it is not displayed to the user and so as to not disturb operations within operating system 108.

The screening task program 122 may comprise a logging tool 128 configured to enter display characteristics and corresponding display management action(s) for an event message that comprises an application window or dialog box into a log report 130. The logging tool 128 may be configured to enter all event messages and associated display characteristics and corresponding display management actions that are passed though message filter 124 into log report 130. The log report 130 may be used by an administrator to analyze the effectiveness of message filter 124 at preventing display of and dispensing with application windows or dialog boxes unrelated to public display application program 120.

The screening task program 122 may comprise a customization tool 132 configured to enable administrative customization of schema 136 to change different display characteristics 138, including different display configuration parameters 140 and different contents 142, different display management actions 144, and links between the display characteristics and display management actions. In other words, customization tool 132 may be configured to enable an administrator to override or extend message filter 124. This may be used to increase logging or reporting, or create more or less complex filtering and/or display management actions that are specific to the implementation of public display application program 120. Further, customization tool 132 may be used to help identify the application window/dialog box by providing the display characteristics to system administrators. In some embodiments, customization tool 132 may take the form of a software development kit (SDK) that allows access to rule engine 134. Rule engine 134 may be changed via the SDK. For example, an administrator may change the rule engine by editing a configuration file. Further, the customization tool may include published software interfaces (SDK) that enable a system administrator to extend or replace the filtering logic of the message filter. For example, this would allow system administrators to write a filter that allows only their own application to be displayed while all others are hidden. Optionally, a customer using the SDK can provide their own code to provide more specific actions by overriding the default behavior.

The screening task program may be configured to detect creation of an application window or dialog box in virtually any suitable manner, and filtering event messages from an event message queue is one non-limiting example.

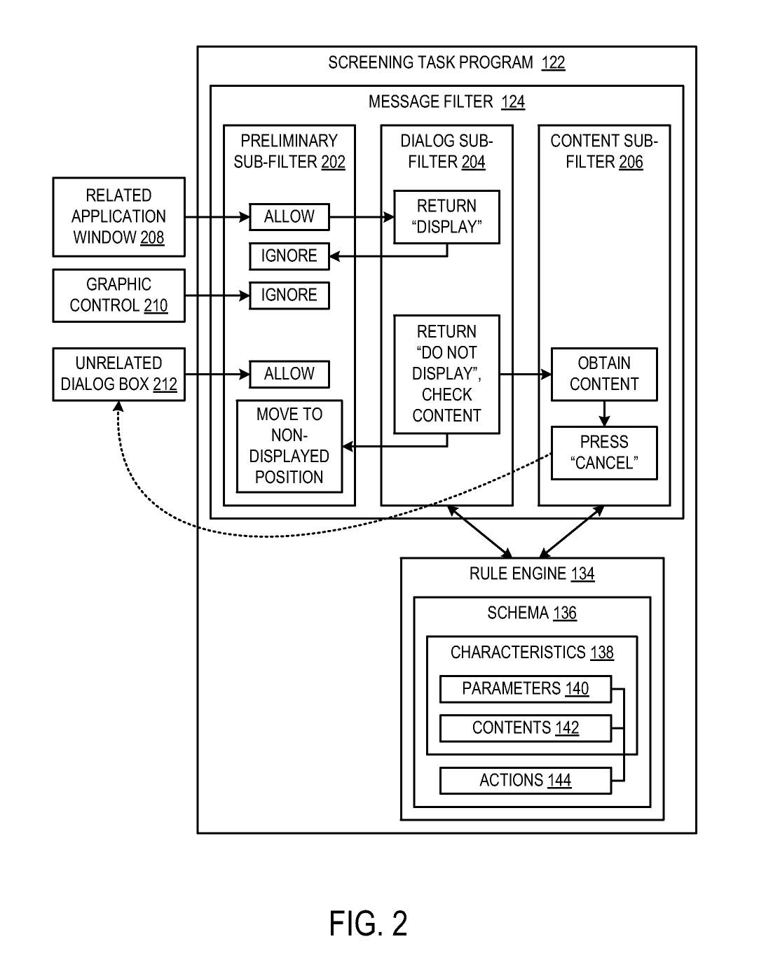

FIG. 2 is a schematic diagram of an embodiment of screening task program 122. The screening task program 122 comprises message filter 124 that comprises three different sub-filters, namely, a preliminary sub-filter 202, a dialog sub-filter 204, and a contents sub-filter 206. The preliminary sub-filter 202 may be configured to ignore event messages that do not include an application window or dialog box. For example, a targeted application window 208, such as an application window provided by public display application program 120 of FIG. 1, may be allowed to pass through preliminary sub-filter 202. As another example, a graphic control 210 may be ignored by preliminary sub-filter 202 to dialog sub-filter 204. As yet another example, non-targeted dialog box 212, such as a dialog box provided by a source other than public display application program 120 may be allowed to pass through preliminary sub-filter 202 to dialog sub-filter 204.

The dialog sub-filter 204 may be configured to obtain display configuration parameters of an event message passed from preliminary sub-filter 202. The display configuration parameters obtained for the event message may be sent to rule engine 134 to identify different display characteristics 138 that are linked to different display management actions 144. The rule engine 134 may be configured to retrieve corresponding display management action(s). For example, dialog sub-filter 204 may be configured to obtain the display configuration parameters for targeted application window 208. Further, dialog sub-filter 204 may send the display configuration parameters to rule engine 134. The rule engine 134 may determine that targeted application window 208 is related to the public display application program based on analysis of the display configuration parameters. As such, rule engine 134 may retrieve a display management action that includes displaying the targeted application window to the user. The screening task program 122 may be configured to perform the display management action to display target application window 208 to the user.

Based on the configuration of the message filter and the rule engine for the public display application program, dialog sub-filter 204 may be configured to pass some event messages to contents sub-filter 206 when analysis of the display configuration parameters produces display management actions that do not fully dispense with the application window or dialog box. For example, non-targeted dialog box 212 may include display configuration parameters that correspond to a display management action that causes non-targeted dialog box 212 to not be displayed to the user. However, additional corresponding display management action(s) may have to be performed on the event message in order to dispense with the application window or dialog box.

The contents sub-filter 206 may be configured to interrogate the application window or dialog box of an event message to obtain the entire contents of the application window or dialog box. The contents of the application window or dialog box may be sent to rule engine 134 to identify different contents 142 that are linked to different display management actions 144. The rule engine 134 may be configured to retrieve corresponding display management action(s) to be performed on the application window or dialog box to dispense with the application window or dialog box. For example, non-targeted dialog box 212 may include contents that are linked to corresponding display management action(s) that include not displaying the non-targeted dialog box and programmatically actuating a “cancel” control button in order to automatically close the non-targeted dialog box.

Besides actions associated with the application window or dialog box, display management actions may include other actions not directly associated with the application window or dialog box. For example, the system may be restarted in response to some application windows or dialog boxes being created. As another example, the screening task program may be configured to send an e-mail in response to an application window or dialog box being created. As another example, metrics on how a particular application window or dialog box is displayed may be tracked.

The message filter 124 and associated sub-filters may be used to perform display management actions that are used to manage an event message that includes an application window or dialog box in order to selectively display and/or dispense with the application window or dialog box. Accordingly, screening task program 122 may be configured to enable an application window or dialog box that is related to the public display application program to be displayed as well as enable an application window or dialog box that is unrelated to the public display application program to not be displayed to the user and the application window or dialog box may be dispensed with suitably. In this way, the user may interact with the public display application program without interference from unrelated application windows or dialog boxes. Further, since unrelated application windows or dialog boxes are not displayed, the user may interact with the public display application in a straightforward manner without confusion. Further still, screening task program 122 may be configured to dispense with application windows or dialog boxes suitably so as to not interfere with operations within the operating system of the computing device.

In the above described embodiment, the layered structure of the sub-filters may improve performance/efficiency of the message filter. In some embodiments, the message filter may be implemented without specific sub-filters or filter layers and another configuration may be used. Moreover, the actions used in the illustrated embodiment are examples. It will be appreciated that display management actions are not restricted to these action, and other actions are allowed which may or may not directly impact the display/user interface.

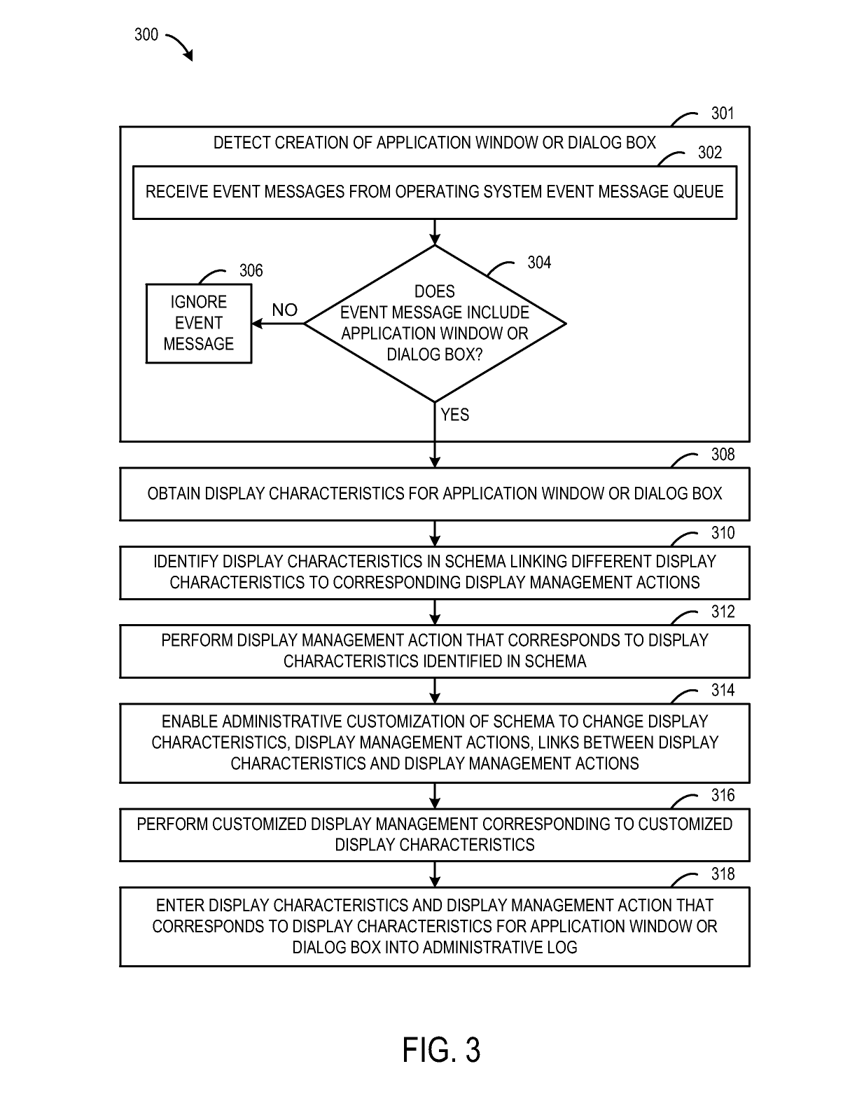

FIG. 3 is a flow diagram of an embodiment of a method 300 for autonomously managing selective display of and/or dispensing with graphical interfaces such as application windows or dialog boxes that would otherwise be displayed by a computing device. At 301, the method may include detecting creation of an application window or dialog box. In some embodiments, application window or dialog box creation detection may be achieved by monitoring an operating system event message queue as described in 302-306. In some embodiment, application window or dialog box creation detection may be achieved in another manner.

At 302, the method may include receiving event messages. For example, the event messages may be received from a message queue 110 of operating system 108 of FIG. 1.

At 304, the method may include determining if an event message comprises an application window or dialog box. In one example, message filter 124 of FIG. 1, and more particularly, preliminary sub-filter 202 of FIG. 2 is configured to make this determination. If it is determined that the event message does not comprise an application window or dialog box, then the method moves to 306. Otherwise the event message comprises an application window or dialog box, and the method moves to 308.

At 306, the event message does not include an application window or dialog box, and thus, the event message is ignored. In one example, message filter 124 of FIG. 1, and more particularly, preliminary sub-filter 202 of FIG. 2 is configured to ignore the event message.

At 308, the method may include obtaining display characteristics for an application window or dialog box attempting to be displayed by the computing device. In one example, message filter 124 of FIG. 1 is configured to obtain the display characteristics for the event message. More particularly, dialog sub-filter 204 of FIG. 2 is configured to obtain display configuration parameters of the event message; and contents sub-filter 206 of FIG. 2 is configured to obtain the contents of the application window or dialog box.

At 310, the method may include identifying the display characteristics of the event message in a schema linking different display characteristics to corresponding display management actions. In one example, message filter 124 is configured to send the display characteristics to rule engine 134 of FIG. 1 and the rule engine is configured to retrieve display management action(s) corresponding to the display characteristics of the event message.

At 312, the method may include performing the display management action(s) that correspond to the display characteristics identified in the schema to selectively display the application window or dialog box and/or dispense with the application window or dialog box. In one example, screening task program 122 of FIG. 1 is configured to perform the corresponding display management action(s) to selectively display and/or dispense with the application window or dialog box of the event message. Furthermore, display management actions may include other actions not directly associated with an application window or dialog box. For example, the screening task program may be configured to send an e-mail in response to an application window or dialog box being created. As another example, metrics on how a particular application window or dialog box is displayed may be tracked.

At 314, the method may include enabling administrative customization of the schema to change one or more of the different display characteristics, the different display management actions, and the different links between the display characteristics and display management actions. In one example, customization tool 132 of FIG. 1 may be configured to enable an administrator to access rule engine 134 to customize the different display characteristics, the different display management actions, and/or the different links between the display characteristics and display management actions. In some embodiments where the rule engine is hard-coded into the screening task program, the different display characteristics, different corresponding display management actions, and/or links may be customized by editing the screening task program. In some embodiments, this feature may be omitted. For example, in configurations in which the rule engine is hard-coded in the screening task program and the screening task program is not customizable, rule engine customization may not be available.

At 316, the method may include performing the customized display management action(s) corresponding to the customized display characteristics. In one example, screening task program 122 of FIG. 1 is configured to perform the customized display management action(s) corresponding to the customized display characteristics identified in the schema to selectively display and/or dispense with the application window or dialog box of the event message.

At 318, the method may include entering the display characteristics and corresponding display management action(s) for the application window or dialog box into an administrative log. In one example, logging tool 128 of FIG. 1 is configured to enter the display characteristics and corresponding display management action(s) performed on the application window or dialog box of all event messages that pass through message filter 124 into log report 130. In some embodiments, this feature may be omitted.

The above described method may be performed to manage selective display of, dispense with, and/or perform an action associated with the application windows or dialog boxes of event messages based on display characteristics of the event messages. Accordingly, application windows or dialog boxes that are unrelated to the public display application program as determined by the display characteristics may not be displayed to the user and the application windows or dialog boxes may be dispensed with suitably with display management actions that correspond to the display characteristics of the event messages. In this way, the user may interact with the public display application program without interference from unrelated application windows or dialog boxes. Further, since unrelated application windows or dialog boxes are not displayed, the user may interact with the public display application in a straightforward manner without confusion caused by display of unrelated application windows or dialog boxes. Further still, the application windows or dialog boxes may be dispensed with suitably so as to not interfere with operation of the computing device.

In some embodiments, the above described method may be performed when instructions held by memory/data-holding sub-system 104 are executed by processing sub-system 102. The instructions may be executed by processing sub-system 102 to carry out some or all aspects of the method. Furthermore, in some embodiments, the instructions may be executed during a public display session of the operating system in which users are blocked from accessing selected application programs or are blocked from accessing application programs other than the public display application program.

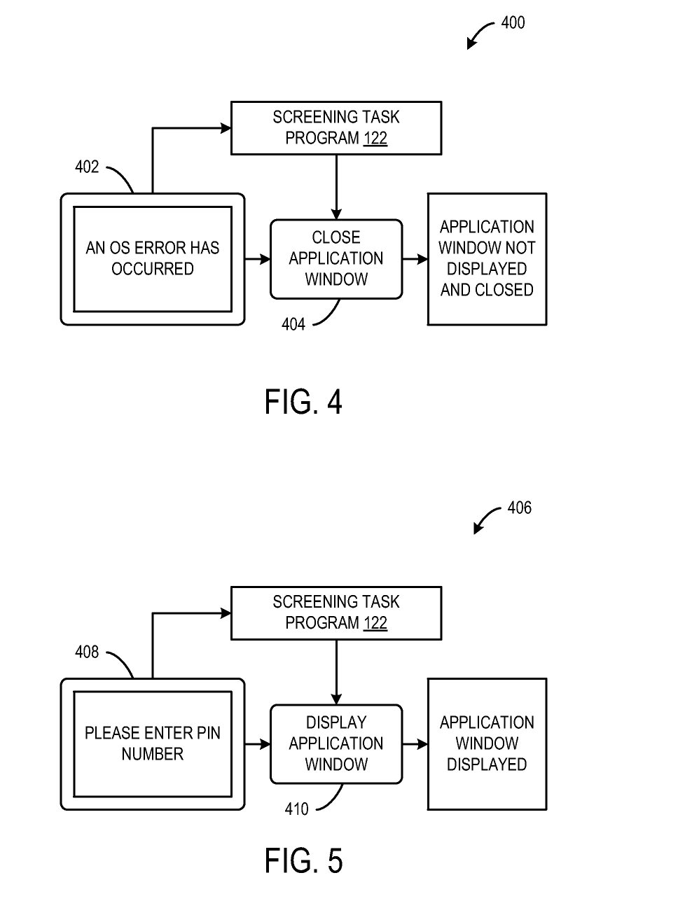

FIG. 4 is a schematic diagram of a use case 400 that illustrates operation of screening task program 122. Use case 400 shows an event message 402 that includes a dialog box that communicates that an operating system error has occurred. The event message 410 is sent to screening task program 122. The screening task program 122 determines that event message 402 comprises a dialog box and obtains display characteristics for event message 402. The screening task program 122 identifies display characteristics of the event message that are linked to a corresponding display management action 404. The screening task program performs display management action 404 on event message 402 which includes not displaying the dialog box and programmatically closing the dialog box. In use case 400, the dialog box of event message 402 is determined to be unrelated to the public display application program and therefore is automatically closed so that it is not displayed to the user.

FIG. 5 is a schematic diagram of another use case 406 that illustrates operation of screening task program 122. The use case 406 shows an event message 408 that includes an application window that prompts the user to enter a pin number. In this use case, the public display application program may be associated with an ATM. The event message 410 is sent to screening task program 122. The screening task program 122 determines that event message 408 comprises an application window and obtains display characteristics for event message 408. The screening task program 122 identifies display characteristics of the event message that are linked to a corresponding display management action 410. The screening task program performs display management action 410 on event message 408 which includes displaying the application window since the application window is determined to be related to the public display application program based on the display characteristics of event message 408. In use case 406, the application window of event message 408 is determined to be related to the public display application program and therefore is automatically displayed to the user.

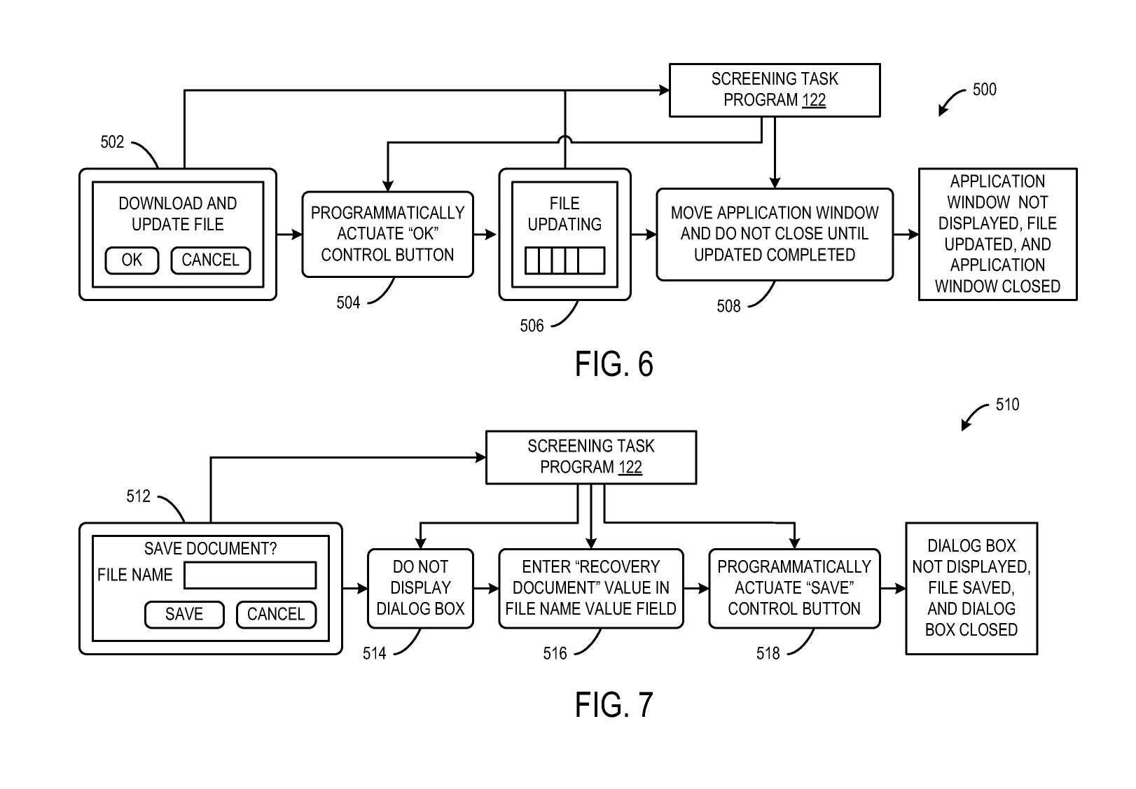

FIG. 6 is a schematic diagram of another use case 500 that illustrates operation of screening task program 122. Use case 500 shows an event message 502 that includes a dialog box that communicates that a file is available to be downloaded and updated. The dialog box includes control buttons to initiate the download and update or cancel the download and update. The event message 502 is sent to screening task program 122. The screening task program 122 determines that event message 502 comprises a dialog box and obtains display characteristics for event message 502. The screening task program 122 identifies display characteristics of event message 502 that are linked to corresponding display management actions 504 and 508. The screening task program performs display management action 504 on event message 502 which includes programmatically actuating the “ok” control button to start the download in order to dispense with the dialog box. Further, screening task program 122 performs display management action 508 on event message 502 which includes moving the dialog box to a position not viewable by a user and not closing the dialog box. In some cases, this may include being displayed on a secondary monitor not viewable by a user. In some cases, this may include being moved to a non-displayed position. Upon download and update of the file screening task program 122 programmatically closes the dialog box. In use case 500, the dialog box of event message 502 is determined to be unrelated to the public display application program and therefore is automatically not displayed to the user, moved to a position not viewable by a user or a non-displayed position in order to allow the download and update to be completed, and then the dialog box is closed.

FIG. 7 is a schematic diagram of another use case 510 that illustrates operation of screening task program 122. Use case 510 shows an event message 512 that includes a dialog box that communicates that a file is available to be saved. The dialog box includes a value field for the file name of the location at which the file is to be saved and control buttons that initiate saving of the file or cancel saving of the file. The event message 512 is sent to screening task program 122. The screening task program 122 determines that event message 512 comprises a dialog box and obtains display characteristics for event message 512. The screening task program 122 identifies display characteristics of event message 512 that are linked to a plurality of corresponding display management actions 514, 516, and 518. The screening task program performs display management action 514 on event message 512 which includes not displaying the dialog box. Further, screening task program 122 performs display management action 516 on event message 512 which includes entering a “recovery document#clock time#” value in the file name value field of the dialog box so that the file can be saved to a location. Further still, screening task program 122 performs display management action 518 on event message 512 which includes programmatically actuating the “save” control button to initiate saving of the file in order to dispense with the dialog box. Upon saving of the file, screening task program 122 programmatically closes the dialog box. In use case 510, the dialog box of event message 512 is determined to be unrelated to the public display application program and therefore is automatically not displayed to the user, moved to a position not viewable by a user or a non-displayed position in order to allow the file to be saved, and then the dialog box is closed.

The above use cases show examples of one or more display management actions that may be performed on an event message to manage selective display of and/or dispense with an application window or dialog box.

It is to be understood that the configurations, use cases, and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

It will be appreciated that the computing devices described herein may be any suitable computing device configured to execute the programs described herein. For example, the computing devices may be a public kiosk, mainframe computer, personal computer, laptop computer, portable data assistant (PDA), computer-enabled wireless telephone, networked computing device, or other suitable computing device, and may be connected to each other via computer networks, such as the Internet. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of autonomously managing selective display of graphical interfaces displayable by a computing device, the method comprising:
detecting creation of an application window or dialog box to be displayed by the computing device;
obtaining display characteristics for a created application window or dialog box, the display characteristics including one or more of display configuration parameters and displayable contents of the created application window or dialog box;
identifying the display characteristics from different display characteristics linked to corresponding display management actions; and
performing a display management action that corresponds to the display characteristics to selectively display the application window or dialog box.

2. The method of claim 1, wherein the display configuration parameters include one or more of a window's application process name, a class identifier, and title text.

3. The method of claim 1, wherein the displayable contents include values associated with graphical controls of the application window or dialog box.

4. The method of claim 1, wherein the display management action includes closing the application window or dialog box.

5. The method of claim 1, wherein the display management action includes moving the application window or dialog box to a position not viewable by a user and not closing the application window or dialog box.

6. The method of claim 1, wherein the display management action includes entering a value into a value field of the application window or dialog box.

7. The method of claim 1, wherein the display management action includes programmatically actuating a control button of the application window or dialog box.

8. The method of claim 1, wherein the display management action includes displaying the application window or dialog box.

9. The method of claim 1 further comprising:
enabling administrative customization to change one or more of display characteristics, display management actions, and links between display characteristics and display management actions; and
performing a customized display management action on the application window or dialog box corresponding to customized display characteristics.

10. The method of claim 1, further comprising:
entering the display characteristics and the display management action that corresponds to the display characteristics for the created application window or dialog box into an administrative log.

11. A computing device comprising:
a processing sub-system; and
a memory/data-holding subsystem holding instructions executable by the processing sub-system to:
receive event messages from an operating system event message queue;
ignore event messages that do not include an application window or dialog box attempting to be displayed by the computing device;
obtain display characteristics for event messages that include an application window or dialog box, the display characteristics including display configuration parameters and displayable contents of the application window or dialog box;
identify the display characteristics in a schema linking different display characteristics to corresponding display management actions; and
perform a display management action that corresponds to the display characteristics identified in the schema on the application window or dialog box to selectively display the application window or dialog box.

12. The computing device of claim 11, wherein the display configuration parameters include one or more of a window's application process name, a class identifier, and title text.

13. The computing device of claim 11, wherein the displayable contents include values associated with graphical controls of the application window or dialog box.

14. The computing device of claim 11, wherein the display management action includes one or more of closing the application window or dialog box, moving the application window or dialog box to a position not viewable by a user and not closing the application window or dialog box, entering a value into a value field of the application window or dialog box, programmatically actuating a control button of the application window or dialog box, and displaying the application window or dialog box.

15. The computing device of claim 11, wherein the instructions are further executable by the processing sub-system to:
enable administrative customization of the schema to change one or more of display characteristics, display management actions, and links between display characteristics and display management actions; and
perform a customized display management action on the application window or dialog box corresponding to customized display characteristics.

16. The computing device of claim 11, wherein the instructions are further executable by the processing sub-system to:
enter the display characteristics and the display management action that corresponds to the display characteristics for event messages that include the application window or dialog box into an administrative log.

17. The computing device of claim 11, wherein the instructions are executed during a public display session of an operating system in which users are blocked from accessing selected application programs.

18. A method of autonomously managing selective display of graphical interfaces displayable by a computing device, the method comprising:
receiving event messages from an operating system event message queue;
ignoring event messages that do not include an application window or dialog box attempting to be displayed by the computing device;
obtaining display characteristics for event messages that include an application window or dialog box, the display characteristics including display configuration parameters including one or more of a window's application process name, a class identifier, and title text and displayable contents of the application window or dialog box including values associated graphical controls of the application window or dialog box;
identifying the display characteristics in a schema linking different display characteristics to corresponding display management actions;
performing a display management action that corresponds to the display characteristics identified in the schema on the application window or dialog box to selectively display the application window or dialog box and/or dispense with the application window or dialog box;
enabling administrative customization of the schema to change one or more of display characteristics, display management actions, and links between display characteristics and display management actions; and
performing a customized display management action on the application window or dialog box corresponding to customized display characteristics.

19. The method of claim 18, further comprising:
entering the display characteristics and the display management action that corresponds to the display characteristics for event messages that include the application window or dialog box into an administrative log.

20. The method of claim 18, wherein performing the display management action includes performing a plurality of actions including not displaying the application window or dialog box, entering a value into a value field of the application window or dialog box, and programmatically actuating a control button of the application window or dialog box in order to dispense of the application window or dialog box.
